(19) United States
(12) Patent Application Publication
(10) Pub. No.: US 2016/0004647 A1
(43) Pub. Date: Jan. 7, 2016

(54) METHOD AND CIRCUIT ARRANGEMENT FOR ACCESSING SLAVE UNITS IN A SYSTEM ON CHIP IN A CONTROLLED MANNER

(71) Applicant: SIEMENS AKTIENGESELLSCHAFT, München (DE)

(72) Inventors: Friedrich EPPENSTEINER, Spitz (AT); Majid GHAMESHLU, Wien (AT); Ulrich HAHN, Neustadt/A. (DE); Herbert TAUCHER, Moedling (AT)

(21) Appl. No.: 14/769,238

(22) PCT Filed: Feb. 12, 2014
(86) PCT No.: PCT/EP2014/052702

§ 371 Date: Aug. 20, 2015

(30) Foreign Application Priority Data
Feb. 28, 2013 (DE) 10 2013 203 365.6

(51) Int. Cl. G06F 12/14; G06F 13/42; G06F 13/40; G06F 13/364

(52) U.S. Cl. CPC G06F 12/1425; G06F 13/364; G06F 13/4282; G06F 13/404; G06F 2212/1052

(57) ABSTRACT

A circuit arrangement and method for accessing slave units in a system on chip in a controlled manner, wherein an access of a master unit of the system on chip to one of the slave units is performed via a network-on-chip bus system using an access address, where a memory protection unit is integrated between the at least one master unit and the network-on-chip bus system, and access authorization of the master unit to a slave unit is checked by the memory protection unit by comparing the access address with specified address sections, and when an unauthorized access of the master unit to a slave unit is identified, the access address is modified by the memory protection unit such that the unauthorized access is terminated in the network-on-chip bus system.

### CROSS-REFERENCE TO RELATED APPLICATIONS

This is a U.S. national stage of application No. PCT/EP2014/052702 filed 12 Feb. 2014. Priority is claimed on German Application No. 10 2013 203 365.6 filed 28 Feb. 2013, the content of which is incorporated herein by reference in its entirety.

### BACKGROUND OF THE INVENTION

1. Field of the Invention

The present invention generally relates to the field of electronic and logic circuits and, more particularly, to the field of application-specific integrated circuits (ASICs). Specifically, the present invention relates to a method for accessing slave units in a system on chip in a controlled manner, and to an associated circuit arrangement. Having at least one master unit, a plurality of subordinate slave units, and a network-on-chip bus system (NoC), where an access of a master unit to a slave unit is effected by an access address via the network-on-chip bus system.

2. Description of the Related Art

Logic and/or electronic circuits, which are realized in particular as integrated circuits, form the basis of all electronics today, particularly in the field of computer technology. Such electronic circuits or systems usually consist of electronic components and electronic circuits or integrated circuits (ICs), which are packaged and wired together on a single substrate (e.g., semiconductor substrate). An integrated circuit therefore consists of a large number of components of different types and connecting conductor tracks on or in a monocrystalline substrate. Only by this integration is it possible to provide a wide range of functionalities and applications in a small space. A multiplicity of applications (e.g., in mobile devices, SIM cards, RFIDs, or mobile phones) can only be technically realized by virtue of integrated circuits, because these applications would otherwise often be too expensive, too complex, too power-hungry or too large (e.g., for inclusion in the respective device). When such logic circuits or integrated circuits are produced for specific applications, they are also referred to as application-specific integrated circuits (ASICs).

A reduction in the size of devices and a continuous increase in the level of integration means that entire systems including, e.g., processors, controllers, memory modules (e.g., RAMs, or ROMs), power management and other components are now packaged on a chip or die. Also referred to as a system on chip (SoC), such systems are used primarily in the field of mobile radio, embedded computers, smartphones, CD and DVD devices, and anywhere in applications where small dimensions are required at the same time as relatively high performance and a wide diversity of tasks.

In the case of a system on chip (SoC), all or many of the functions of the system are integrated on the chip, i.e., in an integrated circuit on a semiconductor substrate. It is unusual today for a system on chip to be developed from scratch, and designs are instead based at least partially on existing and/or outsourced components, i.e., IP core units or IP blocks (e.g., processors, controller units, or peripheral blocks). These IP blocks are acquired as ready-made units or via design licenses, for example, and then used in a new system on chip, either directly or in adapted form. Missing units for the system on chip can then be developed separately for the finished ASIC, for example.

The units of such a system on chip are connected internally via a bus system. Use is often made of hierarchical or at least segmented bus systems, particularly in the case of complex systems on chip. Such bus systems may comprise, e.g., a high-speed system bus, a slower peripheral bus and a register or control bus. One approach for designing flexible and efficient communication connections between IP blocks (e.g., processors, controller units, or peripheral blocks) of a system on chip is the bus system called network on chip (NoC). In a network-on-chip bus system, the information between the individual IP blocks of the system on chip, e.g., processors, memory elements, controllers, or peripheral units, is not exchanged via an internal bus, but via a layered bus architecture that is designed to have distribution points like a network. In this way, information or accesses from one component to another component of the system on chip can be switched on a path from a source component to a destination component, e.g., as a point-to-point connection or as a multipath connection via a plurality of links, as in the case of, e.g., routing in a packet-switched network. In this case, the information forwarding or the access from the source component to the destination component is effected, e.g., via an access address that is used for the purposes of routing.

The master-slave model is often used for the organization and distribution of accesses, or tasks between various components of a system on chip. The respective tasks are distributed between supervisory components (master units) and subordinate components (slave units) in this way, and management of the access to shared resources (e.g., memory units) is regulated. A master-slave model is used primarily if one or more components, such as processors or controllers are responsible for the control and task distribution of other components (e.g., special processors or peripheral units) or for regulating accesses to other components (e.g., memory units, or bus systems).

Systems on chip must often satisfy rigid security requirements, and it is therefore necessary to control accesses and/or access authorizations from master units to slave units, in order to prevent authorized accesses. In the case of commercially available central-processing-unit components or CPUs for systems on chip, e.g., a memory management unit (MMU) or memory protection unit (MPU) is integrated for the purpose of access control. In addition to other tasks, the MMU or MPU also performs memory protection tasks. In this way, individual memory areas or accesses to slave units for the purpose of, e.g., executing code or performing write functions, can be blocked by the respective CPU.

However, in addition to at least one CPU, systems on chip usually comprise further master units from which the slave units of the system on chip are accessed. In this case, direct memory access (DMA) is a type of access whereby a master unit (e.g., peripheral unit) can directly access a slave unit or a memory unit via the bus system (e.g., NoC) independently of the CPU. At present, however, no control of the accesses is performed by other IP components (e.g., processors) of the system on chip in this case. This means that unauthorized accesses to slave units can be performed using DMA, for example, and therefore represent a security risk.

EP 2 461 251 A1 discloses an exemplary method for controlling an access to a memory unit. In this case, each processor unit is assigned a memory protection unit, by which a connection to the memory unit is then set up via a system bus. The access of a processor unit to the memory unit is therefore always performed via the memory protection unit, where the accesses of the processors have different access authorizations and/or memory areas may be blocked for specific applications of the processors. Using the method of EP 2 461 251 A1, the accesses by a processor are then checked by two access control units of the relevant memory protection unit in each case, and are only allowed if the access is considered to be authorized by both access control units. In this case, information is held, e.g., in a first access control unit of the memory protection unit, specifying which applications of the processor are allowed to access which memory area, and the corresponding access types or authorizations (e.g., read/write access, or read access) are then stored in a second access control unit of the memory protection unit. The method disclosed in EP 2 461 251 A1 therefore has the disadvantage that considerable overheads are required for controlled access to the memory unit, particularly in the programming of the access control units of the memory protection units. Each memory protection unit must be programmed separately and specifically according to the applications of the processor concerned. Moreover, the dual checking of an access by two access control units results in a time delay for the access of the processor, which must also be taken into consideration.

A further way to allow control of accesses to slave units in a system on chip is, for example, integration of an MPU or memory protection functionality in the respective bus system that is used, e.g., in the network-on-chip bus system. However, this approach has the disadvantage that the functionality of the bus system must be enhanced as a consequence. This enhancement is often associated with considerable overhead, because network-on-chip bus systems can also be outsourced as IP components for systems on chip, for example, and must then be upgraded specifically to include the memory protection function, for example. This functional enhancement might then also result in time delays during accesses or a lengthening of the access time, which can significantly impair the performance of the system on chip.

### SUMMARY OF THE INVENTION

In view of the foregoing, it is therefore an object of the invention to provide a method and a circuit arrangement by which, in a simple manner and without additional overheads, controlled accesses to slave units in a system on chip can be achieved with very little or no access time delay.

This and other objects and advantages are achieved in accordance with the invention by a method and a circuit arrangement in which a memory protection unit is integrated between the at least one master unit and the network-on-chip bus system. An access authorization of the at least one master unit to the at least one slave unit is then checked by the memory protection unit by comparing an access address with specified address sections. If an unauthorized access of the at least one master unit to the at least one slave unit is identified, the access address is modified by the memory protection unit such that the unauthorized access is terminated in the network-on-chip bus system.

The main aspect of the method in accordance with the invention consists in being able to control accesses from master units that are used in a system on chip to slave units of the system on chip, without additional overhead such as adaptations to IP blocks used as master units. Unauthorized accesses by a master unit to, e.g., read-only areas of slave units or memory units, or to blocked slave units or memory areas, can be prevented very easily and without significant overhead in this way. It is also unnecessary, e.g., to enhance the existing network-on-chip system with additional control functionality to recognize and prevent unauthorized accesses. Moreover, the method in accordance with the invention, and in particular a modification of access address that might be performed, keeps any additional latency or time delay of an access caused by the checking in the memory protection unit to a minimum, or produces no additional latency or time delay at all. This means that the method in accordance with the invention results in little or no increase in the access times of the at least one master unit to the at least one slave unit of the system on chip, and the performance and efficiency of the system on chip are therefore not impaired.

In the case of unauthorized accesses of the at least one master unit, the access address is advantageously mapped onto an address section of the network-on-chip bus system that is unused for this master unit. An unused address section in the network-on-chip system is not occupied for the respective master unit and/or no address of a slave unit (e.g., memory unit) is assigned to this address section in the network-on-chip bus system for the purpose of access. Consequently, the unauthorized access of the master unit is terminated in the network-on-chip bus system, because the access cannot be forwarded to any slave unit as a destination unit.

If an unauthorized access by the at least one master unit of the system on chip to the least one slave unit or to a slave unit of the system on chip is terminated, provision is preferably made in this case for an interrupt to be transmitted in the network-on-chip bus system. The interrupt can be used to notify, e.g., a control unit or CPU of the system on chip in a simple manner of an interruption or termination of the access of the respective master unit to a slave unit. An interrupt can be used, e.g., to perform a synchronization of the control unit or CPU of the system on chip with irregular unpredictable events, such as a premature termination of an access of a master unit to a slave unit or a memory area. The interrupt, which may also include an error-symptom register, is then serviced by the CPU and it is then very quickly possible for the CPU to continue processing a microprogram, for example.

Ideally, the at least one master unit can be authorized at least for read/write access, for read-only access, or for no access to the at least one slave unit. If a master unit is authorized for, e.g., read/write access to a slave unit and this is established in the memory protection unit, the access address is forwarded from the memory protection unit to the network-on-chip bus system without change, for example. If a specific type of access, such as write access, or read access, is not allowed for the respective master unit in relation to a slave unit or a memory area, or if the respective slave unit or the respective memory area is blocked for the respective master unit, the access address is modified by the memory protection unit after the access authorizations have been checked, and is in this case mapped onto an unused address section of the network-on-chip bus system for this master unit.

In order to achieve this mapping, e.g., access indications for the respective master units of the system on chip, in particular the address sections for comparison with the access address and hence for checking the access authorizations of a master unit, are stored in software-readable registers of a register unit of the memory protection unit. Setting the address sections for comparison with the access address of the master units of the system on chip is ideally performed via a security application, such as by using dedicated security software.

In accordance with an effective embodiment of the inventive method, provision is made for the memory protection unit to be configured by a specific trusted master configuration unit during an initialization phase via a register interface, such as an advanced peripheral bus register interface. This means that, in the memory protection unit or possibly in a plurality of memory protection units, the address sections for comparison with access addresses are stored in the register unit, e.g., during the initialization phase, when such as the system on chip is also configured. The register unit can then be blocked for further accesses or changes, for example.

Alternatively, it is also possible for the address section stored in the memory unit to be configured and/or changed via a register interface, such as an advanced peripheral bus register interface using specific encryption information. It is then advantageously possible to also make changes after an initialization phase using the specific encryption information (e.g., 32-bit key). As a result, the memory protection unit can also be adapted to meet requirements, such as while the system on chip is being used.

It is also an object to provide a circuit arrangement for performing the method in accordance with the invention. This circuit arrangement, by virtue of which it is possible to effect controlled accesses in a system on chip, consists at least of at least one master unit, at least one slave unit, and a network-on-chip bus system for connections between master and slave units. In the inventive circuit arrangement, a memory protection unit is integrated between the at least one master unit and the network-on-chip bus system. This memory protection unit is configured to check accesses by comparing access addresses with specified address sections, and to modify access addresses in the case of unauthorized accesses to the at least one slave unit from the at least one master unit, such that these unauthorized accesses are blocked in the network-on-chip bus system.

The advantages that can be obtained by using the inventive circuit arrangement consist in particular in being able to prevent unauthorized accesses from master units to slave units in a simple manner and without additional overheads (e.g., in the design or in development of the system on chip). In order to allow the control of accesses, it is not necessary to change, functionally enhance or adapt, e.g., IP blocks that are used as master units for the system on chip, or a network-on-chip bus that is used. Moreover, the access latency or time delay of an access to a slave unit, caused by the checking of the respective access authorizations, is kept as short as possible or is not increased at all by the inventive circuit arrangement. Likewise, it is not necessary to stop the protocol of the network-on-chip bus system, which would have an effect on access latencies, and instead an unauthorized access is simply terminated or blocked in the network-on-chip bus system.

The memory protection unit advantageously includes at least one control logic for checking the access address, a modification unit for modifying the access address, and at least one register unit for storing the specified address sections and/or access indications. The control logic can be used, e.g., to interpret and process settings and signals from the master unit that is accessing a slave unit. With reference to this information, the control logic can then trigger and/or perform checks in relation to access authorizations, for example, by comparing an access address with the specified address sections. If an unauthorized access is identified, the control logic can then initiate a modification of the access address by the modification unit.

The at least one register unit of the memory protection unit is used to store the specified address sections for the comparison with the respective access address, and therefore the access indications or access authorizations of a master unit to the slave units and/or memories (memory areas) that are used in the system on chip in each case. Like the memory protection unit, the at least one register unit of the memory protection unit is advantageously configurable via a register interface, such as an advanced peripheral bus register interface. The configuration can be performed via a specific trusted master configuration unit, e.g., during an initialization phase. The memory protection unit and/or the register unit can then be blocked for access or changes, for example. Alternatively, it is however also possible in particular to allow the address sections in the at least one register unit to be changed via the register interface with knowledge of specific encryption information (e.g. 32-bit key, etc.). Without knowledge of this encryption information, the at least one register unit of the memory protection unit is protected against accesses via the register interface.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is now explained by way of example with reference to the appended figure in which:

FIG. 1 shows an exemplary and schematic circuit arrangement for performing a method which allows controlled accesses to at least one slave unit in a system on chip, and an execution of said method according to the invention; and

FIG. 2 is a flowchart of the method in accordance with the invention.

### DETAILED DESCRIPTION OF THE EXEMPLARY EMBODIMENTS

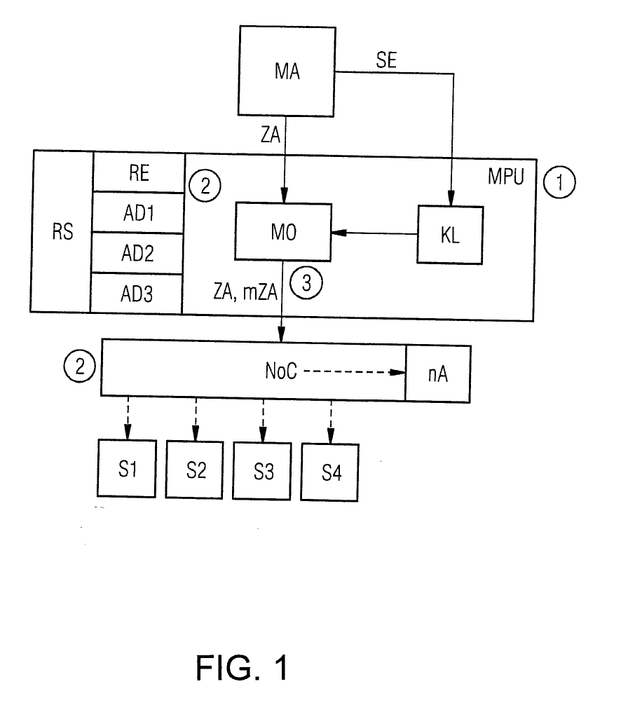

In an exemplary and schematic manner, FIG. 1 shows a circuit arrangement for performing the inventive method for controlled accesses by at least one master unit MA to at least one slave unit S1, S2, S3, S4 in a system on chip. The exemplary circuit arrangement is at least part of the system on chip. In addition to the circuit arrangement shown, the system on chip may comprise further components or IP units, such as a control unit or CPU, input and output units, and further master units (e.g., coprocessors). For the sake of simplicity, however, these components or IP units are not shown.

The inventive circuit arrangement includes at least one master unit MA, such as a direct memory access of a peripheral unit, controller, or coprocessor, and at least one slave unit S1, S2, S3, S4. A slave unit S1, S2, S3, S4 may be, e.g., a peripheral unit, an input/output unit, or a memory unit or memory area. A master unit MA may have, e.g., write access, read access or execute access to a slave unit S1, S2, S3, S4, depending on access authorization, or the slave unit S1, S2, S3, S4 may be blocked for the master unit MA. An access of the master unit MA to a slave unit S1, S2, S3, S4 is performed using an access address ZA via a network-on-chip bus system NoC of the circuit arrangement, where the bus system creates a connection between the components of the circuit arrangement or the system on chip. Addresses or address sections are accordingly reserved in the network-on-chip bus system NoC for accesses to the slave units S1, S2, S3, S4. The network-on-chip bus system NoC also has at least one unreserved or unused address section nA which is not reserved for the master unit MA, for example.

In the circuit arrangement in accordance with the invention, a memory protection unit MPU is integrated between the at least one master unit MA and the network-on-chip system NoC. The memory protection unit MPU has at least one control logic KL, a modification unit MO, and at least one register unit RE. A register interface RS, such as an advanced peripheral bus register interface, is also provided.

The control logic KL of the memory protection unit MPU is used, e.g., to process setting information and signal information SE of the at least one master unit MA and to initiate a check of the access addresses ZA transferred from the master unit MA. If necessary, the modification unit MO can modify access addresses ZA in the event of an unauthorized access of the master unit MA to a slave unit S1, S2, S3, S4, such that the access of the master unit is terminated in the network-on-chip bus system NoC. This means that if an unauthorized access of the master unit MA is identified by the memory protection unit MPU, the access address ZA is changed to a modified access address mZA which, in the network-on-chip bus system NoC, is mapped onto the unused address section nA of the network-on-chip bus system NoC.

In order to identify unauthorized accesses of the master unit MA, specified address sections AD1, AD2, AD3 are stored in the register unit RE of the memory protection unit MPU. These access indications may be read and processed, e.g., via a software application of the control logic KL, for example. The address sections AD1, AD2, AD3 may store, e.g., access indications for full access (e.g., write and read access) to the slave units S1, S2, S3, S4 in a first address section AD1, access indications for restricted access (e.g., read access only) to the slave units S1, S2, S3, S4 in a second address section AD2, and access indications for blocked access to the slave units S1, S2, S3, S4 in a third address section AD3. In response to an access of the master unit MA, the access address ZA is then compared with the specified address sections AD1, AD2, AD3 and it is thereby established whether an access is authorized or unauthorized.

The register interface RS is provided for the purpose of configuring the memory protection unit MPU and/or the register unit. The configuration may be performed, e.g., during an initialization phase, such as when initializing the system on chip, which represents a generic platform and only receives its functionality by a corresponding configuration/initialization, i.e., via a specific trusted master configuration unit. If there is a plurality of memory protection units MPU in a system on chip, the address sections AD1, AD2, AD3 at a top level may be placed in secure areas, for example. This means that the respective register unit RE or memory protection unit MPU is blocked for accesses or changes following the configuration.

Alternatively, such as in the case of complex systems on chip having a plurality of memory protection units MPU, it is also possible to allow the address sections AD1, AD2, AD3 stored in the register unit RE of the memory protection unit MPU to be configured or changed, via the register interface RS, with knowledge of and using specific encryption information (e.g., 32-bit key). The address sections AD1, AD2, AD3 stored in the register unit RE are then protected by the encryption information and can be changed using the encryption information, if necessary.

In order to perform the inventive method and for the purpose of controlling accesses of the master unit MA to a slave unit S1, S2, S3, S4 in the system on chip, the memory protection unit MPU is integrated between the master unit MA and the network-on-chip bus system NoC in a first method step 1. If a slave unit S1, S2, S3, S4 is to be accessed by the master unit MA, the setting information and signal information SE of the master unit MA is transferred to the control logic KL of the memory protection unit MPU in a second method step 2, and the access address ZA is likewise transferred to the modification unit MO of the memory protection unit MPU. The access address ZA is then compared with the specified address sections AD1, AD2, AD3 by the memory protection unit MPU or by the control logic KL and the modification unit MO in the second method step. This means that the respective access authorizations of the master unit MA are checked with respect to those slave units S1, S2, S3, S4 that the master unit MA is to access.

Depending on the specified address section AD1, AD2, AD3 into which the access address ZA of the master unit MA falls, in a third method step 3 the access address ZA of the master unit is then either forwarded unchanged to the network-on-chip bus system NoC or modified by the modification unit MO of the memory protection unit MPU. For example, if the master unit MA requires write and read access to slave unit S1, S2, S3, S4 and if the access address ZA is found in the first address section AD1 for full or write and read access, the access address ZA is forwarded unchanged to the network-on-chip bus system NoC in the third method step 3. Correspondingly, the network-on-chip bus system NoC then passes the access to the slave unit S1, S2, S3, S4 to which the master unit MA requires write and read access.

If the master unit MA requires read access to a slave unit Si, S2, S3, S4 and if the master unit MA is also authorized for this, when the access address ZA is compared with the specified address sections AD1, AD2, AD3 in the second method step 2, the memory protection unit MPU determines that the access address in the second address section is suitable for restricted access or for read access only. In the third method step 3, the access address ZA of the master unit MA is then transferred unchanged to the network-on-chip bus system NoC. An address of the corresponding slave unit S1, 52, S3, S4 is then determined in the network-on-chip bus system on the basis of the access address in the fourth method step 4, and the access of the master unit MA is forwarded to the slave unit Si, S2, S3, S4. The read access to the slave unit S1, S2, S3, S4 can then be performed by the master unit MA.

However, if the master unit MA is only authorized for read access to the slave unit S1, S2, S3, S4 and nonetheless attempts a write and read access to the slave unit S1, S2, S3, S4, in the second method step 2 the memory protection unit MPU establishes that the access address ZA lies in the second address section AD2 for read access only, and that the master unit MA is not authorized for full access (writing and reading). In the third method step 3, the modification unit MO of the memory protection unit MPU then changes the access address ZA into a modified access address mZA. The modified access address mZA is then forwarded to the network-on-chip bus system NoC. Since the modified access address mZA is mapped onto the address section nA which is not used in the network-on-chip bus system NoC, this unauthorized access of the master unit MA is terminated in the network-on-chip bus system NoC in the fourth method step 4. A termination of the access can then be notified to the control unit or CPU of the system on chip, e.g. by an interrupt including an error-symptom register.

A similar approach is adopted if, e.g., the master unit MA attempts a write and read access or read only access to a blocked slave unit S1, S2, S3, S4. Based on the access address ZA of the master unit MA, the memory protection unit MPU establishes in the second method step 2 that the master unit MA is not authorized for any access to the slave unit S1, S2, S3, S4. Here, the access address ZA is found in the third address section AD3 for blocked accesses. In the third method step 3, the access address ZA is then changed by the modification unit MO of the memory protection unit MPU into the modified access address mZA. The modified access address mZA is again transferred to the network-on-chip bus system NoC. In the fourth method step 4, it is then established there that the modified access address mZA points to the unused address section nA of the network-on-chip bus system NoC, and the access of the master unit MA is terminated. This can again be notified to the CPU of the system on chip by an interrupt.

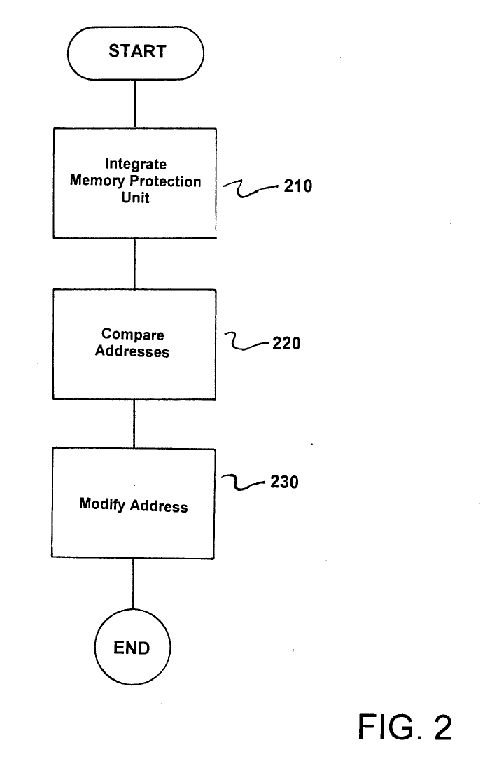

FIG. 2 is a flowchart of the method for controlled accesses by at least one master unit (MA) to at least one slave unit (S1, S2, S3, S4) via a network-on-chip bus system (NoC) in a system on chip, where an access of the at least one master unit (MA) to the at least one slave unit (S1, S2, S3, S4) via the network on chip bus system (NoC) is performed via an access address (ZA). The method comprises integrating a memory protection unit (MPU) between the at least one master unit (MA) and the network-on-chip bus system (NoC), as indicated in step 210.

The access address (ZA) is compared with specified address sections (AD1, AD2, AD3) to check an access authorization of the at least one master unit (MA) to the at least one slave unit (Si, S2, S3, S4) by the memory protection unit (MPU), as indicated in step 220.

The access address (ZA) is modified (3) by the memory protection unit (MPU) if the unauthorized access of the at least one master unit (MA) is identified, as indicated in step 230. An unauthorized access is then terminated (4) in the network on chip bus system (NoC).

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A method for controlled accesses by at least one master unit to at least one slave unit via a network-on-chip bus system in a system on chip, an access of the at least one master unit to the at least one slave unit via the network-on-chip bus system being performed via an access address, the method comprising:
integrating a memory protection unit between the at least one master unit and the network-on-chip bus system
comparing the access address with specified address sections to check an access authorization of the at least one master unit to the at least one slave unit by the memory protection unit; and
modifying the access address by the memory protection unit such that an unauthorized access is terminated in the network-on-chip bus system if the unauthorized access of the at least one master unit is identified.

12. The method as claimed in claim 11, wherein the access address is mapped onto an address section of the network-on-chip bus system in cases of an unauthorized accesses of the at least one master unit, said address section being unused for this master unit.

13. The method as claimed in claim 11, wherein an interrupt is transmitted in cases of an unauthorized access of the at least one master unit, said access being terminated in the network-on-chip bus system.

14. The method as claimed in claim 12, wherein an interrupt is transmitted in cases of an unauthorized access of the at least one master unit, said access being terminated in the network-on-chip bus system.

15. The method as claimed in claim 11, wherein the at least one master unit is authorized at least for one of (i) read/write access, (ii) read access read-only access and (iii) no access to the at least one slave unit.

16. The method as claimed in claim 12, wherein the at least one master unit is authorized at least for one of (i) read/write access, (ii) read access read-only access and (iii) no access to the at least one slave unit.

17. The method as claimed in claim 13, wherein the at least one master unit is authorized at least for one of (i) read/write access, (ii) read access read-only access and (iii) no access to the at least one slave unit.

18. The method as claimed in claim 11, wherein the address sections for the comparison with the access address of the at least one master unit are set by a security application and subsequently stored in a register unit of the memory protection unit.

19. The method as claimed in claim 11, wherein the memory protection unit (MPU) is configured by a specific trusted master configuration unit via a register interface during an initialization phase.

20. The method as claimed in claim 11, wherein the address sections stored in the memory protection unit are at least one of configured and changed via a register interface using specific encryption information.

21. The method as claimed in claim 11, wherein the at least one slave unit comprises at least one of a memory unit and an input/output unit.

22. A circuit arrangement for controlled accesses in a system on chip, comprising:
at least one master unit;
at least one slave unit;
a network-on-chip bus system for connecting the at least one master unit and the at least one slave unit;
a memory protection unit integrated between the at least one master unit and the network-on-chip bus system, said memory protection unit being configured to check accesses by comparing access addresses with specified address sections and to modify access addresses in cases of unauthorized accesses to the at least one slave unit by the at least one master unit, such that these unauthorized accesses are terminated in the network-on-chip bus system.

23. The circuit arrangement as claimed in claim 22, wherein the memory protection unit includes at least one control logic for checking access addresses, a modification unit for modifying access addresses, and at least one register unit for storing the specified address sections.

24. The circuit arrangement as claimed in claim 23, wherein the at least one register unit of the memory protection unit is configurable via a register interface.

25. The circuit arrangement as claimed in claim 23, wherein the at least one register unit of the memory protection unit is configurable via a register interface.
